(19) United States
(12) Patent Application Publication
(10) Pub. No.: US 2013/0119674 A1
(43) Pub. Date: May 16, 2013

(54) BAMIJI PERMANENT MAGNET GENERATOR (BPMG)

(71) Applicant: Bamiji Regnault, Jos (NG)

(72) Inventor: Bamiji Regnault, Jos (NG)

(21) Appl. No.: 13/294,170

(22) Filed: Nov. 10, 2011

(51) Int. Cl. H02K 7/18; H02N 11/00

(52) U.S. Cl. 290/1 A; 74/DIG. 9

(57) ABSTRACT

The invention is a magnet generator that continues in operation non-stop until stop by the operator with it's main source of power being permanent magnets which are axially and diagonally arrange to create magnetic field when there is an impulse of rotation initiated by the auto-rotation starter device. Hence it require no fuel to keep on operating, but the magnetic forces of the magnets acting on each magnet are so arranged on the two opposite aluminum disc, such arrangement and initial spinning of the auto-rotation starting device creates a non-stop attraction and repulsion of the magnets, hence keeping the machine in constant motion, such motion is transmitted to the alternator through a shaft, there-by producing 240 VAC@50 Hz. The current invention will be a global solution to power generation that is safe; economical; maintenance free; environmentally friendly and an all-locations installation technology master-piece.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF THE INVENTION

1.) Technical Field

This invention is directed to magnet energy generators in more particular one that requires limited fuel.

2.) Description of the Prior Art

Global challenges of power generation with the current systems in use are multi-faceted. Most challenges of late are the global researches going on to develop clean energy technology that is environmentally friendly. Enormous resources are being committed to achieve this, with America taking the lead.

While some of the power generation plants rely on elements of weather (Wind & Solar power plants systems); and hydro-power systems have their biggest challenges in water levels that occasionally drops. Furthermore, global attention of late has been on the imminent danger associated with nuclear power generation. The cases of fukushima and Chernobyl nuclear disasters are clear reference.

Lately there has been an isolated case of anti-nuclear power plant protest round the globe because of its far reaching danger of radiation/contamination.

Not every nation has the geological and geographical features that can produce efficient hydro-power generation and same could be said of Wind/Solar power systems. Similarly, power generation systems based on Hydrocarbon/coal go with a lot of environmental Pollutions/hazards.

It is therefore, imperative that with global drive for clean energy technology; a radical departure from all these modes of power generation can never be better timed than now and it will address most, if not all, the shortcomings of the present systems.

It is against this backdrop that the current invention is conceived to revolutionaries the whole concept of power generation that is not only environmentally friendly; but a radical departure from the concept of present power generation systems. Technically; it is a ‘free’ power generation invention that does not need any form of hydro carbon input; no geological/geographical features required and it is maintenance free in use.

There exists a need for new sources of power generation.

### SUMMARY OF THE INVENTION

The current invention is a BPM (BAMIJI PERMANENT MAGNET) generator that operates on the following principles:

When the starter knob in turn on (clock-wise), current is transmitted to the auto-rotation starting device, this spins at the speed of 3800 rpm, in the process it rotates the shaft and stator on which the axially and diagonally magnetized magnets were carefully arranged. Due to the speed of the auto-rotation starter device acting on the stator, the stator receives an initial spin and began to spin at the speed of 3800 rpm with the magnets strongly clip to them.

The magnets produce magnetic forces as they rotate that act on each other, the axially magnetized magnets and the diagonally magnetized magnets, producing a force of attraction and repulsion continuously, since they are axially and diagonally magnetized and arranged, they continue in perpetual motion attracting and repelling each other. This motion is further transmitted through a shaft attached to an alternator, which spins at the speed of 3200 rpm, producing 240V, at 50 Hz.

When this invention is fully developed it will be the global solution to power generation that is safe; economical; maintenance free; environmentally friendly and an all-locations installation technology master-piece.

### BRIEF DESCRIPTION OF THE DRAWINGS

These and other features of the invention will be more clearly understood from a consideration of the following description, taken in connection with the accompanying drawings, in which:

FIG. 1 shows the device with its major components.

### MAIN PARTS OF THE BPM GENERATOR

1. Alternator
2. Auto-rotation starter device
3. Shaft (stainless steel)
4. Bearing
5. Starter knob
6. 24 pieces diagonally and axially magnetized permanent magnets
7. 2 Aluminum disc plates as stator
8. 12 volt battery for starter
9. Transformers (step up and step down)
10. Steel base frame
11. Aluminum covering
12. Sound damper foams
13. Diode for battery charging
14. 220 VAC Output adapter
15. Indicator
16. Rubber stand
17. Wire accessories and sockets.

### DETAILED DESCRIPTION

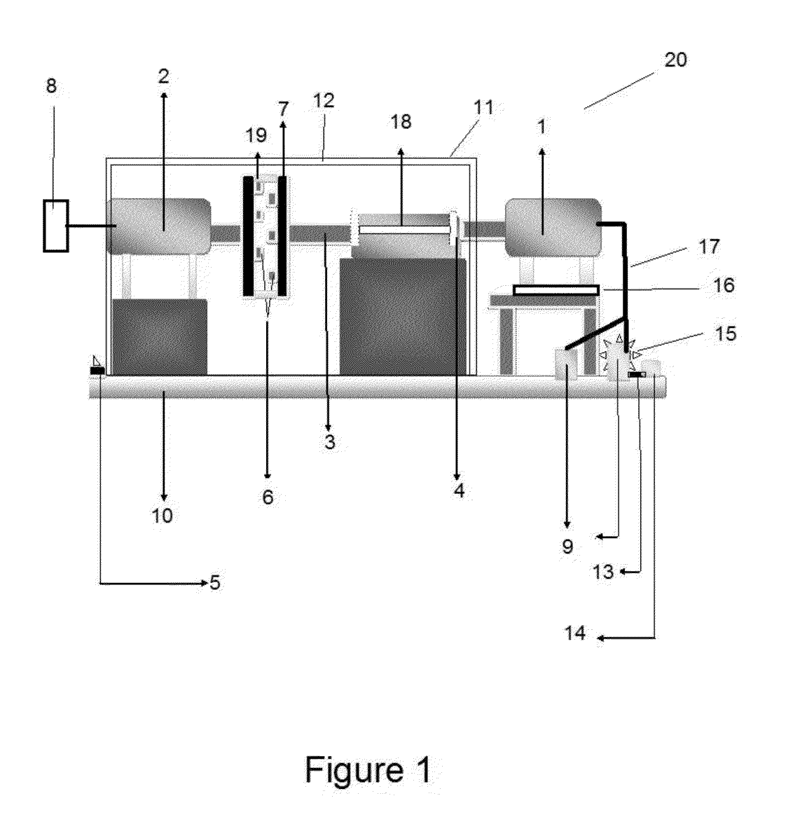

The proposed invention is a BPMG (BAMIJI PERMANENT MAGNET GENERATOR) 20 that continues in operation non-stop until stop by the operator, it's main source of power are the permanent magnets 6 which are axially and diagonally arrange to create magnetic field when there is an impulse of rotation initiated by the auto-rotation starter device 2. Hence it require no fuel to keep on operating, but the magnetic forces of the magnets 6 acting on each magnet 6 are so arranged on the two opposite aluminum disc, such arrangement and initial spinning of the auto-rotation starting device creates a non-stop attraction and repulsion of the magnets 6, hence keeping the machine in constant motion, such motion is transmitted to the alternator through a shaft 3, there-by producing 240 VAC@50 Hz.
As shown in FIG. 1, the main parts of the BPM generator are the Alternator 1, Auto-rotation starter device 2, Shaft (stainless steel) 3, Bearing 4, Starter knob 5, 24 pieces Diagonally and axially magnetized permanent magnets 6, 2 Aluminum disc plates as stator 7, 12 volt battery for starter 8, Transformers (step up and step down) 9, Steel base frame 10, Aluminum covering 11, Sound damper foams 12, Diode for battery charging 13, 220 VAC Output adapter 14, Indicator 15, Rubber stand 16 and Wire accessories and sockets 17.

### Principles of the BPM Generator

The BPM generator 20 operates on the following principles:

When the starter knob 5 in turn on (clock-wise), current is transmitted to the auto-rotation starting device 2 from the battery for starting 8, this spins at the speed of 3800 rpm, in the process it rotates the shaft 3 and stator 7 on which the axially and diagonally magnetized magnets 6 were carefully arranged. Due to the speed of the auto-rotation starter device 2 acting on the stator 7, the stator 7 receives an initial spin and began to spin at the speed of 3800 rpm with the magnets 6 strongly clip to them.

As they rotate, the magnets 6 produce magnetic forces that act on each other, the axially magnetized magnets 6 and the diagonally magnetized magnets 6, producing a force of attraction and repulsion continuously, since they are axially and diagonally magnetized and arranged, they continue in continuous motion attracting and repelling each other. This motion is further transmitted through a shaft 3 attached to an alternator 1, which spins at the speed of 3200 rpm, producing 240V, at 50 Hz. A transformer 9 is also attached to step up or step down the voltage depending on where the voltage will be put into use through wires 17.

When the generator 20 needs to be stopped, the starter knob 5 is turned in opposite direction, this drag the other stator plate 7 backward weakening the magnetic force between the two stator plates 7, hence the stator plates 7 gradually comes to a stop, and the generator 20 stops.
In the preferred embodiment, there is an Aluminum covering 11 with sound damper foams 12. The Aluminum covering 11 covers the Alternator, Auto-rotation starter device 2, the disc plates as stator 7 with the magnets 6 and the shaft 3 up to the alternator 1 including the bearings 4 which are in a bearings compartment 18.

The generator 20 will also have an indicator 15 such as a light which will shine to indicate that the generator 20 is working. In one embodiment, the indicator 15 is attached to the transformers 9. The Generator 20 has Diode that is used for battery charging which 13 is attached to the transformers 9.

Some of the components like the alternator 1 will have rubber stands 16 to protect against electrical conductivity and vibration reduction.

In the preferred embodiment, there will be 24 pieces of diagonally and axially magnetized permanent magnets 6 attached to 2 Aluminum disc plates as stator 7 with Stabilizers 19 between the two plates 7.

### Conclusion

BPMG is a fuel-less generator that requires little or no maintenance for a very long period, since it has no heavy mechanical parts to wear away, but the bearings, which need to be greased once in a year to keep it in normal smooth working condition.

BPMG is not only a fuel-less generator but noiseless, as compared to conventional generators, it is an environmentally safe generator as there are no exhaust fumes to pollute the environment; it is also an all-weather generator which does not require the sun as do Solar panels or Wind for Wind turbine generator or even Water level change for Hydropower generation.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A generator comprising; a starter knob and a battery connected to an auto-rotation starting that rotates a shaft and stator on which axially and diagonally magnetized magnets are attached, where the auto-rotation starter device acting on the stator makes the stator receives an initial spin and began to spin with the magnets producing magnetic forces that act on each other, the axially magnetized magnets and the diagonally magnetized magnets producing a force of attraction and repulsion which is transferred to a shaft attached to an alternator.

2. A method to generate electricity comprising: having a generator that has a starter knob and a battery connected to an auto-rotation starting, having the auto-rotation starting rotate a shaft and stator on which axially and diagonally magnetized magnets are attached, having the auto-rotation starter device acting on the stator making the stator receive an initial spin and began to spin with the magnets producing magnetic forces that act on each other, the axially magnetized magnets and the diagonally magnetized magnets producing a force of attraction and repulsion which is transferred to a shaft attached to an alternator.
